(19) United States
(12) Patent Application Publication
(10) Pub. No.: US 2017/0274753 A1
(43) Pub. Date: Sep. 28, 2017

(54) DRIVE DEVICE FOR HYBRID VEHICLE

(71) Applicant: TOYOTA JIDOSHA KABUSHIKI KAISHA, Toyota-shi (JP)

(72) Inventor: Shigeru OKUWAKI, Gotemba-shi (JP)

(73) Assignee: TOYOTA JIDOSHA KABUSHIKI KAISHA, Toyota-shi (JP)

(21) Appl. No.: 15/443,183

(22) Filed: Feb. 27, 2017

(30) Foreign Application Priority Data
Mar. 24, 2016 (JP) 2016-059932

(51) Int. Cl. B60K 6/445; F16G 13/04; F16H 7/06; B60K 6/365; F16H 37/08

(52) U.S. Cl. CPC B60K 6/445; B60K 6/365; F16H 37/0806; F16H 7/06; F16G 13/04; B60Y 2200/92; Y10S 903/911

(57) ABSTRACT

A hybrid vehicle is provided in which deterioration of vehicle mounting characteristics is suppressed. A drive device of the vehicle includes a power splitting mechanism having a sun gear to which a first motor-generator is linked, a carrier to which an output shaft is linked, and a ring gear to which an engine is linked, and a speed reduction mechanism that transmits the torque of the output shaft to a differential mechanism while reducing the rotational speed of the output shaft. The speed reduction mechanism is built up as a chain transmission mechanism which includes a driving sprocket that rotates together with the output shaft, a driven sprocket that is provided to the differential mechanism, and a belt chain that is fitted around these sprockets.

### TECHNICAL FIELD

The present invention relates to a drive device for a hybrid vehicle to which an engine and an electric motor-generator are provided as power sources for propulsion.

### BACKGROUND ART

As a hybrid vehicle, a vehicle is per se known in which a first motor-generator is linked to a sun gear of a single pinion type planetary gear mechanism, an engine is linked to a carrier thereof, and an output member is linked to a ring gear thereof, and in which torque of the output member is transmitted thereby to a differential mechanism via a speed reduction mechanism (refer to Patent Document #1). The speed reduction mechanism is provided in order to enhance the transmission efficiency, and typically includes a chain mechanism that transmits the rotation of the output member without varying its rotational speed and a speed reduction gear train that then reduces the rotational speed of the rotation transmitted by the chain mechanism and transmits the resulting rotation to the differential mechanism.

### CITATION LIST

### Patent Literature

Patent Document #1: Japanese Laid-Open Patent Publication Heisei 9-226392.

### SUMMARY OF INVENTION

### Technical Problem

In the case of a hybrid vehicle of the type described above, the rotating elements of the planetary gear mechanism are typically arranged in a nomogram in the following order: the sun gear, the carrier, and the ring gear. Since, during high speed travel or the like, the system efficiency is improved by operating the rotational speed of the first motor-generator (which is linked to the sun gear) to make it around zero, accordingly a speed increasing state is established in which the rotational speed of the output member (which is linked to the ring gear) becomes higher than the rotational speed of the engine (which is linked to the carrier). In view of such circumstances, it is necessary to provide a speed reduction gear train in order to reduce the rotational speed of the output member (whose rotational speed has thus been increased) to an appropriate rotational speed, and it is necessary to ensure sufficient mounting space in the vehicle for providing this speed reduction gear train.

Moreover, it might also be contemplated to construct a speed reduction mechanism using only a chain mechanism comprising a driving sprocket and a driven sprocket, which can provide the appropriate speed reduction ratio. However there is a limitation upon increase of the size of the driven sprocket when this driven sprocket is provided to the differential mechanism, since in some cases the driven sprocket becomes too large and the casing for housing the driven sprocket is increased in size, so that a risk arises of the casing coming into contact with the road surface. Due to this, if an attempt is to be made to obtain the appropriate speed reduction ratio, it is necessary to reduce the diameter of the driving sprocket. Generally, as the diameter of the sprocket becomes smaller, the pitch of the chain becomes smaller and the tension of the chain becomes greater, and accordingly it is necessary for the width of the chain to endure this tension. And the greater the chain width becomes, the worse the vehicle mounting characteristics become.

Accordingly, the object of the present invention is to provide a hybrid vehicle capable of suppressing deterioration of vehicle mounting characteristics.

### Solution to Technical Problem

One aspect of the present invention provides a drive device for a hybrid vehicle comprising: an engine; a motor-generator; an output member that outputs torque; a power splitting mechanism having a first rotating element, a second rotating element, and a third rotating element which are arranged on a nomogram in order of the first rotating element, the second rotating element, and the third rotating element, and also arranged so that the engine is linked to a first one which is any one of either the first rotating element or the third rotating element, the motor generator is linked to a second one which is any one of either the first rotating element or the third element but different from the first one, and the output member is linked to the second rotating element; a differential mechanism that distributes torque to left and right drive wheels; and a speed reduction mechanism that transmits the torque of the output member to the differential mechanism, and reduces speed of rotation of the output member; wherein the speed reduction mechanism is configured as a chain transmission mechanism comprising a driving sprocket that rotates integrally with the output member, a driven sprocket provided to the differential mechanism and having a larger diameter than the driving sprocket, and a belt chain that is fitted around the driving sprocket and the driven sprocket.

According to this drive device, no speed reduction gear train for reducing the rotational speed of the output member is required, since the speed reduction mechanism is configured as a chain transmission mechanism. Accordingly, it is not necessary to provide any vehicle mounting space for housing any speed reduction gear train. Furthermore, with this drive device, the output member is linked to the second rotating element that is positioned in the center on the nomogram of the power splitting mechanism, and the engine is linked to the first rotating element or to the third rotating element, which are arranged on both sides of the second rotating element. Due to this, it is not necessary to set the speed reduction ratio very high, since there are many opportunities to drive in a speed reduction state in which the rotational speed of the output member becomes lower than the engine rotational speed. Thus since, in order to obtain the appropriate speed reduction ratio, it will be sufficient to make the ratio of the diameters of the driving sprocket and the driven sprocket small, accordingly the result of relaxation of the constraint upon reduction of the diameter of the driving sprocket, is that it is possible to suppress enlargement of the chain width of the belt chain. Due to this, it is possible to suppress deterioration of the vehicle mounting characteristics due to increase of the chain width of the belt chain.

Generally, a chain link that starts to engage with a sprocket executes an up and down motion, since it undergoes a polygonal motion while the sprocket rotates through one pitch from the position at which the engagement has started. Furthermore, even after the chain link has completed engagement with the sprocket, it still executes a similar up and down movement. This type of up and down motion becomes greater the smaller is the diameter of the sprocket, since the disparity between the polygonal motion and the circular motion becomes greater. And it is per se known that the noise generated at the belt chain becomes greater, the greater is the disparity between the up and down motion generated at the driving sprocket and the up and down motion generated at the driven sprocket.

In consideration of the above, in one embodiment of the present invention, the belt chain may comprise a plurality of chain links that are engaged to the driving sprocket and to the driven sprocket; each of the plurality of chain links may have has: a first tooth surface that is positioned in the chain link at a side of a forward rotational direction which is a direction in which the driving sprocket and the belt chain engaged to the driving sprocket rotate during forward movement of the hybrid vehicle, and a second tooth surface that is positioned in the chain link at a side of a reverse rotational direction which is opposite to the forward rotational direction, and that opposes the first tooth surface; and each first tooth surface may have a raised portion that bulges out toward the second tooth surface. With the drive device according to this aspect of the present invention, the first tooth surface and the second tooth surface of each of the chain links are formed asymmetrically, since the first tooth surface that is positioned at a side of the forward rotational direction in the chain link has the raised portion that bulges out towards the second tooth surface that is positioned at a side of the reverse rotational direction in the chain link. Due to this, when the chain link starts to engage with the driving sprocket, initially a driving tooth portion of the driving sprocket comes into contact with the first tooth surface of the chain link, and the up and down motion of the chain link that is generated at the driving sprocket becomes small. And since, because of this, the disparity between the up and down motion of the chain link generated at the smaller diameter driving sprocket and the up and down motion of the chain link generated at the larger diameter driven sprocket is reduced or cancelled, accordingly it is possible to suppress noise generated at the belt chain.

In the above embodiment, the driving sprocket may have a plurality of driving tooth portions that are formed at a predetermined pitch, and each of the plurality of driving tooth portions may have a first driving side tooth surface that is positioned at the side of the forward rotational direction in the driving tooth portion and a second driving side tooth surface that is positioned at the side of the reverse rotational direction in the driving tooth portion; and, when a straight line that connects a vertex of the driving tooth portion to a rotational center of the driving sprocket is taken as a reference, the first driving side tooth surface may be bulged out in a direction away from the straight line, as compared to the second driving side tooth surface. With the drive device according to this aspect of the present invention, since the first driving side tooth surface and the second driving side tooth surface are formed as being asymmetric, accordingly, when the chain link starts to engage to the driving sprocket, it is possible for the first driving side tooth surface of the driving tooth portion and the first tooth surface of the chain link more reliably to come into contact with one another first. And, due to this, the beneficial effect for suppression of noise generated at the belt chain is enhanced.

Further, in the above embodiment of the present invention, the driven sprocket may have a plurality of driven tooth portions that are formed at a predetermined pitch, and each of the plurality of driven tooth portions may have a first driven side tooth surface that is positioned at the side of the forward rotational direction in the driven tooth portion and a second driven side tooth surface that is positioned at the side of the reverse rotational direction in the driven tooth portion; and, when a straight line that connects a vertex of the driven tooth portion to a rotational center of the driven sprocket is taken as a reference, the second driven side tooth surfaces may be bulged out in a direction away from the straight line, as compared to the first driven side tooth surface. With the drive device according to this aspect of the present invention, since the second driven side tooth surface is formed to bulge out with respect to the first driven side tooth surface and they are formed so as to be asymmetric, accordingly, when the chain link starts to engage to the driven sprocket, the chain link initially comes into contact with a second driven side tooth surface of the driven sprocket, and the up and down motion of the chain link generated at the driven sprocket becomes small. Since, due to this, the disparity between the up and down motion of the chain link generated at the smaller diameter driving sprocket and the up and down motion of the chain link generated at the larger diameter driven sprocket is reduced or cancelled, accordingly it is possible to suppress noise generated at the belt chain.

### BRIEF DESCRIPTION OF DRAWINGS

FIG. 1 is a diagram schematically showing principal portions of a vehicle to which a drive device according to a first embodiment of the present invention is applied;

FIG. 2 is a diagram schematically showing part of the structure of FIG. 1 as seen in the direction shown by an arrow sign II in FIG. 1;

FIG. 3 is a diagram showing a state of engagement of a driving sprocket and a belt chain;

FIG. 4 is a diagram showing a state of engagement of a driven sprocket and the belt chain;

FIG. 5 is a diagram showing the details of a chain link;

FIG. 6 is a partial enlarged view of the driving sprocket;

FIG. 7 is an enlarged view of a portion VII of FIG. 6;

FIG. 8 is a partial enlarged view of of the driven sprocket;

FIG. 9 is an enlarged view of a portion IX of FIG. 8;

FIG. 10 is a diagram showing a nomogram for the drive device of FIG. 1;

FIG. 11 is a diagram showing a nomogram according to a first linking configuration;

FIG. 12 is a diagram showing a nomogram according to a second linking configuration;

FIG. 13 is a diagram showing a nomogram according to a third linking configuration;

FIG. 14 is a diagram showing a first example in which the arrangement of various elements of the vehicle shown in FIG. 1 is changed;

FIG. 15 is a diagram showing a second example in which the arrangement of various elements of the vehicle shown in FIG. 1 is changed;

FIG. 16 is a diagram schematically showing principal portions of a vehicle to which a drive device according to a second embodiment of the present invention is applied; and

FIG. 17 is a diagram showing a nomogram for the drive device of FIG. 16.

### DETAILED DESCRIPTION OF INVENTION

### Embodiment #1

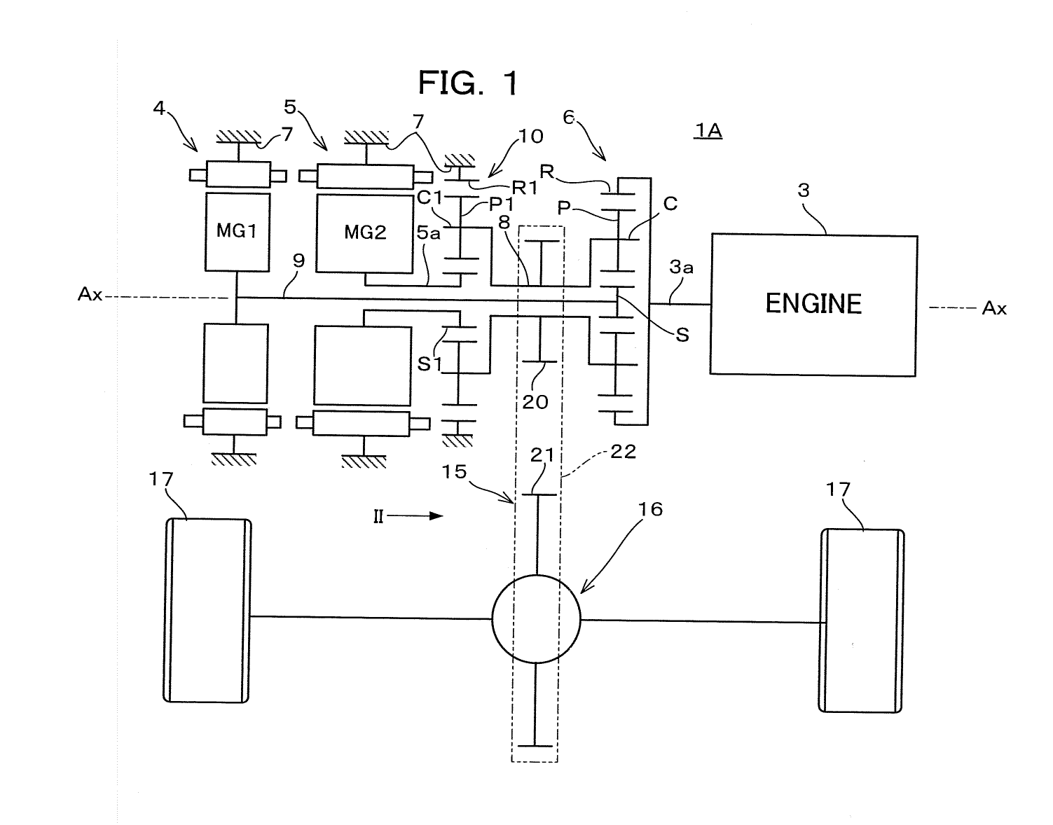

As shown in FIG. 1, a vehicle 1A is built as a hybrid vehicle in which a plurality of power sources are combined. As power sources for propulsion, the vehicle 1A comprises an engine 3 that is built as an internal combustion engine and two motor-generators 4 and 5. The engine 3 is an internal combustion engine of the spark ignition type, and has a plurality of cylinders not shown in the figures.

The engine 3 and the first motor-generator 4 are linked to a power splitting mechanism 6. The first motor-generator 4 functions as a generator that generates electricity when it is receiving power that has been taken off from the engine 3 by the power splitting mechanism 6, and also functions as an electric motor when it is being driven by AC electrical power. In a similar manner, the second motor-generator 5 also can function both as an electric motor and as a generator. Each of these motor-generators 4 and 5 is electrically connected to a battery not shown in the figures. It should be understood that, in the appended figures, the first motor-generator 4 is also denoted by the reference symbol MG1 and the second motor-generator 5 is also denoted by the reference symbol MG2, and they will sometimes be referred to in that manner herein.

The power splitting mechanism 6 is built as a single pinion type planetary gear mechanism. The power splitting mechanism 6 comprises a sun gear S that is an externally toothed gear wheel, a ring gear R that is an internally toothed gear wheel and that is disposed coaxially with the sun gear S, and a carrier C that supports a pinion P so that it can rotate freely, this pinion P being meshed with the sun gear S and with the ring gear R and being capable of revolving together with the carrier C. The engine torque outputted by the engine 3 is transmitted to the ring gear R of the power splitting mechanism 6. The first motor-generator 4 is linked to the sun gear S of the power splitting mechanism 6. And torque outputted from the power splitting mechanism 6 via the carrier C is transmitted to an output shaft 8, which serves as an output member. The output shaft 8 is formed with a hollow internal cavity, and a transmission shaft 9 is inserted in this hollow cavity for transmitting the torque of the first motor-generator 4. Each of a crankshaft 3a of the engine 3, the output shaft 8, and the transmission shaft 9 is mounted so as to be rotatable around a common axial line Ax as center.

The second motor-generator 5 is linked to the output shaft 8 via a motor speed reduction device 10. This motor speed reduction device 10 is built as a single pinion type planetary gear mechanism, and comprises a sun gear S1 that is linked to the motor shaft 5a of the second motor-generator 5, a ring gear R1 that is fixed to a casing 7 which is a predetermined fixed element, and a carrier C1 supporting a pinion P1 that is meshed with both the sun gear S1 and the ring gear R1, and that is capable both of rotating and revolving together with the carrier C1. The carrier C1 is linked to the output shaft 8.

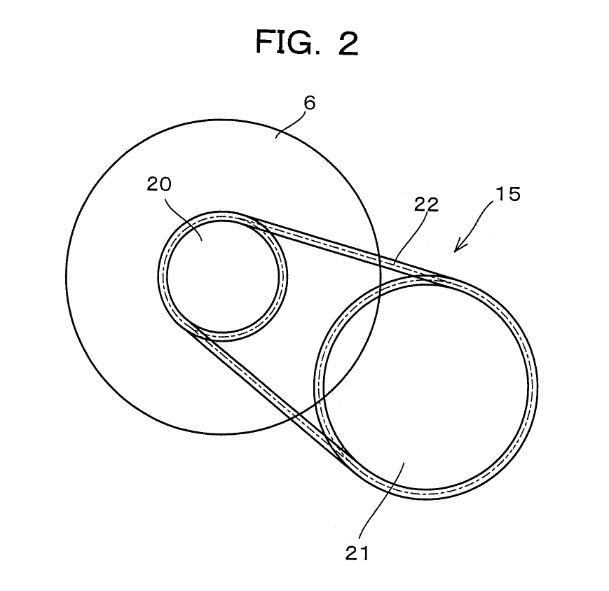

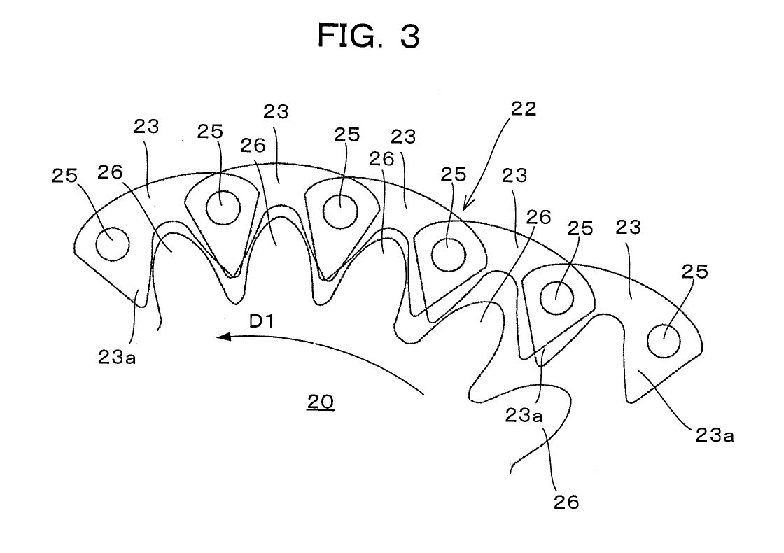

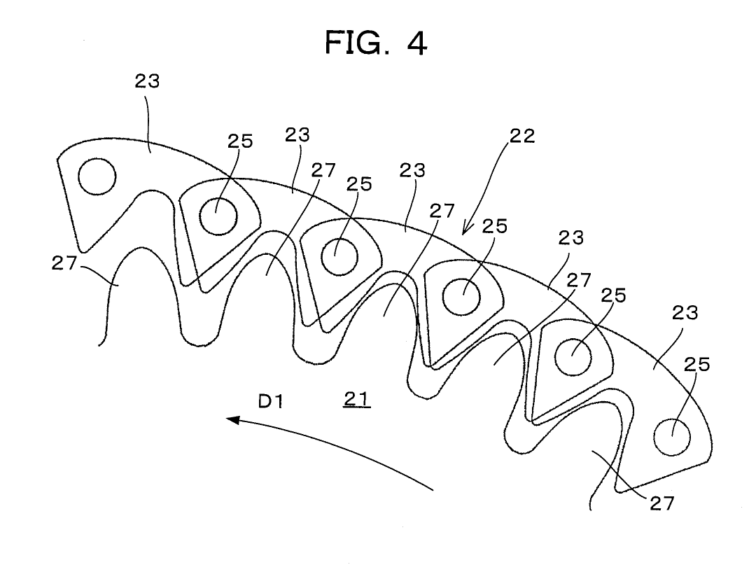

Torque is transmitted from the output shaft 8 to a differential mechanism 16 via a speed reduction mechanism 15. The speed reduction mechanism 15 reduces the speed of the rotation of the output shaft 8 and transmits the result to the differential mechanism 16. And the differential mechanism 16 splits the torque transmitted to itself between left and right drive wheels 17. As also shown in FIG. 2, the speed reduction mechanism 15 is built as a belt transmission mechanism, and comprises a driving sprocket 20 that rotates together with the output shaft 8, a driven sprocket 21 that is provided to the differential mechanism 16 and that has a larger diameter than that of the driving sprocket 20, and a belt chain 22 that is fitted over and around the driving sprocket 20 and the driven sprocket 21. The belt chain 22 is a so-called silent chain, and, as shown in FIGS. 3 and 4, is built from a plurality of chain links 23 each having a pair of left and right claws 23a, all these links 23 being connected together into an endless chain by pins 25. Each of the chain links 23 is built up from a predetermined number of plates, all having the same shape and being laminated together so as to yield the desired thickness (i.e. chain width).

As shown in FIG. 3, the driving sprocket 20 has a plurality of driving tooth portions 26 that are formed at a predetermined pitch, and the chain links 23 of the belt chain 22 are engaged with these driving tooth portions 26. When the vehicle 1A is moving forward, the driving sprocket 20 and the belt chain 22 that is engaged therewith rotate in the forward rotational direction shown by the arrow D1, and, along with power being transmitted from the driving sprocket 20 to the belt chain 22, power is also transmitted from the belt chain 22 to the driven sprocket 21, as shown in FIG. 4. Just as in the case of the driving sprocket 20, a plurality of driven tooth portions 27 are formed upon the driven sprocket 21 at the same pitch as the driving sprockets 20 are, and the chain links 23 of the belt chain 22 are engaged with these driven tooth portions 27.

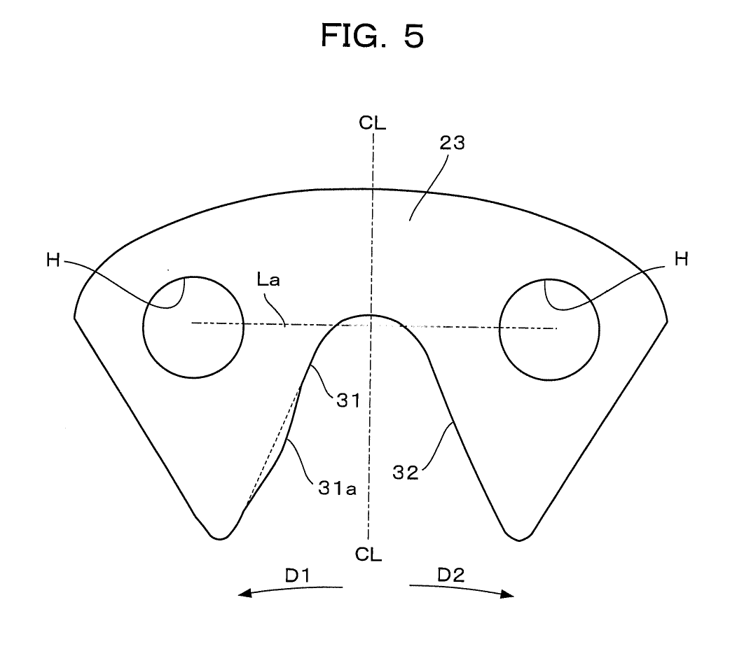

As shown in FIG. 5, each of the chain links 23 has a first tooth surface 31 and a second tooth surface 32 that mutually oppose one another. With respect to the direction in which the belt chain 22 rotates, the first tooth surface 31 is positioned at a side of the forward rotational direction D1 in the chain link 23, while the second tooth surface 32 is positioned in the chain link 23 at a side of the reverse rotational direction D2, which is opposite to the forward rotational direction D1. The first tooth surface 31 has a raised portion 31a that bulges outward toward the second tooth surface 32. Due to the fact that the first tooth surface 31 has this raised portion 31a, the first tooth surface 31 and the second tooth surface 32 are formed asymmetrically with respect to the center line CL of the chain link 23. This center line CL corresponds to the perpendicular bisector of the line segment La drawn between the centers of the pair of pin holes H for the pins 25. Since the first tooth surface 31 and the second tooth surface 32 are formed asymmetrically with respect to the center line CL, accordingly, when the chain links 23 are first engaged over the driving sprocket 20, initially, due to the driving tooth portions 26 of the driving sprocket 20 coming into contact against the first tooth surfaces 30, the up and down motion of the chain links 23 generated at the driving sprocket 20 becomes small. Due to this, it is possible to suppress noise generated at the belt chain 22, since the disparity between the up and down motion of the chain links 23 generated at the driving sprocket 20 having the smaller diameter, and the up and down motion of the chain links 23 generated at the driven sprocket 21 having the larger diameter, is reduced or canceled.

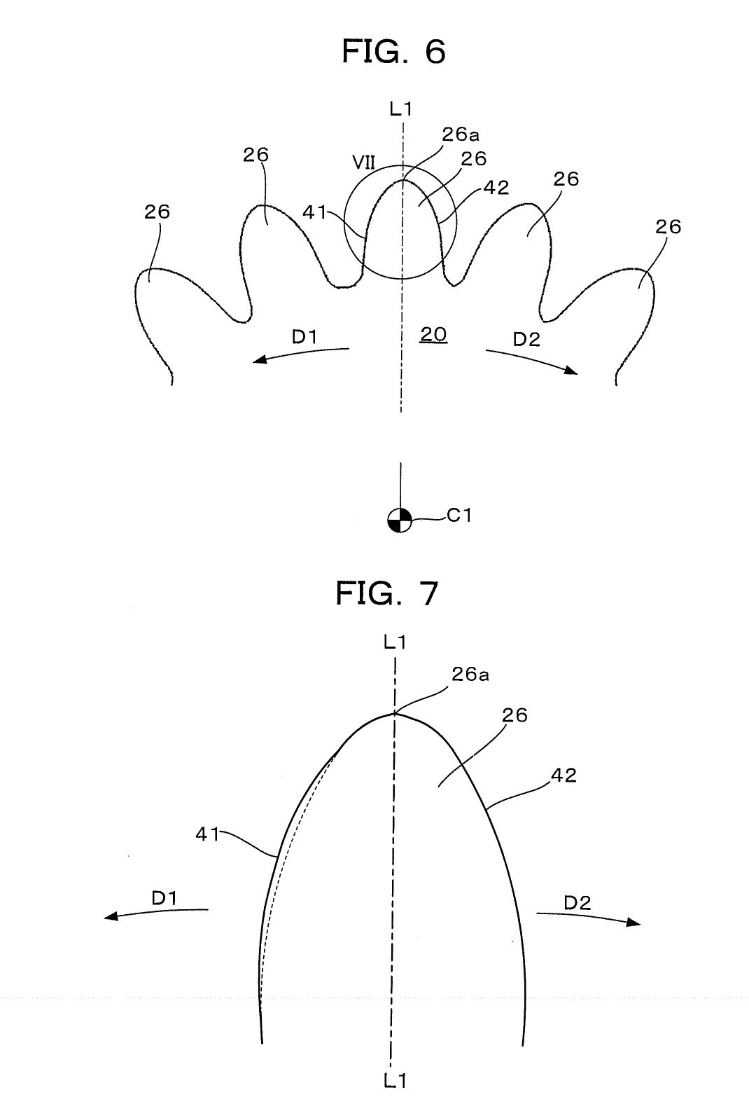

Furthermore, as shown in FIGS. 6 and 7, each driving tooth portion 26 of the driving sprocket 20 has a first driving side tooth surface 41 that is positioned at the side of the forward rotational direction D1 in the driving tooth portion 26, and a second driving side tooth surface 42 that is positioned at the side of the reverse rotational direction D2 in the driving tooth portion 26. With a straight line L1 that joins the vertex 26a of the driving tooth portion 26 and the rotational center C1 of the driving sprocket 20 being taken as a reference, the first driving side tooth surface 41 bulges out more in the direction away from the straight line L1 (Le. to the left side in FIG. 7), as compared to the second driving side tooth surface 42. In other words the driving tooth portion 26 is formed to be asymmetric, with the first drive tooth surface 41 being bulged out more with respect to the straight line L1 than the second driving side tooth surface 42. Due to this it is possible to ensure, when the chain links 23 are first engaged over the driving sprocket 20, that the first driving side tooth surfaces 41 and the first tooth surfaces 31 of the chain links 23 are more reliably initially contacted together (refer to FIG. 4). And, due to this, the beneficial effect is enhanced of suppression of noise generated at the belt chain 22 due to contacting of the first driving side tooth surfaces 41 of the driving tooth portions 26 of the driving sprocket 20 against the raised portions 31a of the first tooth surfaces 31 of the chain links 23.

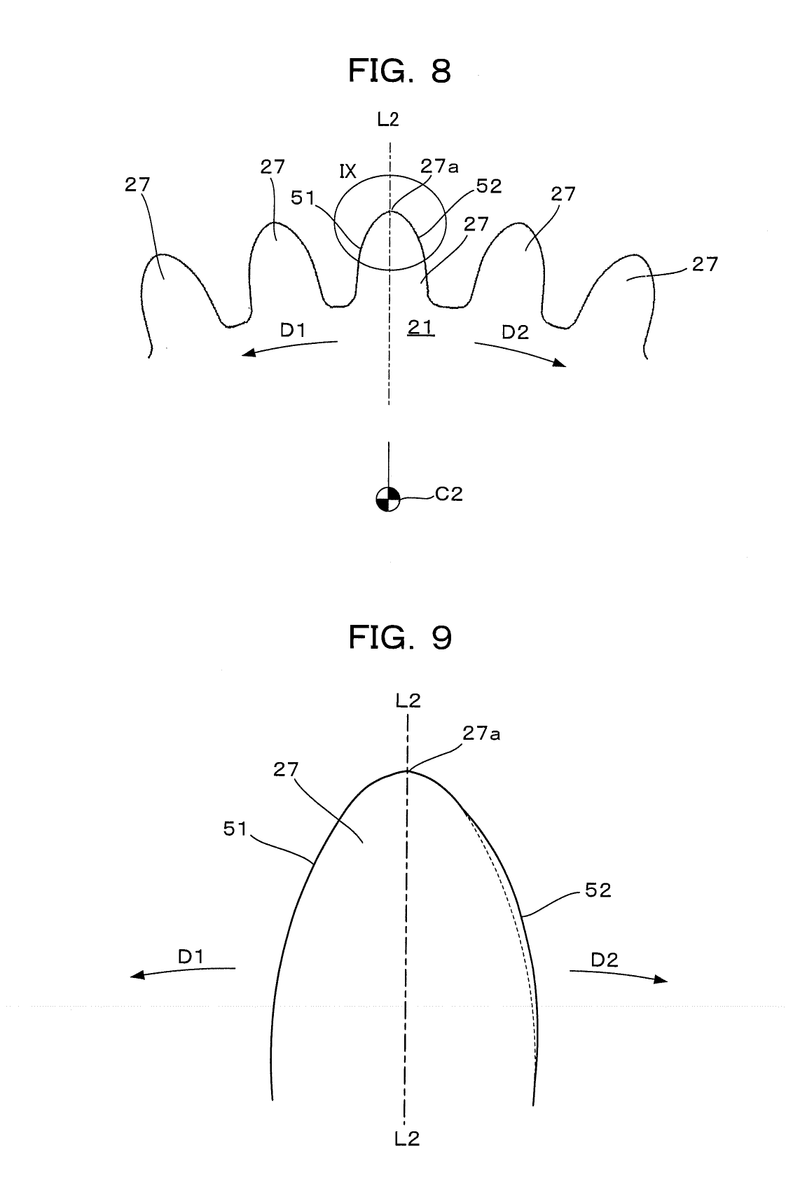

Yet further, as shown in FIGS. 8 and 9, each driven tooth portion 27 of the driven sprocket 21 has a first driven side tooth surface 51 that is positioned at the side of the forward rotational direction D1 in the driven tooth portion 27, and a second driven side tooth surface 52 that is positioned at the side of the reverse rotational direction D2 in the driven tooth portion 27. With a straight line L2 that joins the vertex 27a of the driven tooth portion 27 and the rotational center C2 of the driven sprocket 21 being taken as a reference, the second driven side tooth surface 52 bulges out more in the direction away from the straight line L2 (i.e. to the right side in FIG. 9), as compared to the first driven side tooth surface 51. In other words the driven tooth portion 27 is formed to be asymmetric, with the second driven side tooth surface 52 being bulged out more with respect to the straight line L2 than the first drive tooth surface 51. Due to this the up and down motion of the chain links 23 generated at the driven sprocket 21 becomes smaller, because the chain links 23 initially contact against the second driven side tooth surfaces 52 of the driven sprocket 21 when the chain links 23 are first engaged over the driven sprocket 21. And, due to this, suppression of noise generated at the belt chain 22 is yet further improved, since the disparity in the up and down motion of the chain links 23 described above is further reduced or canceled.

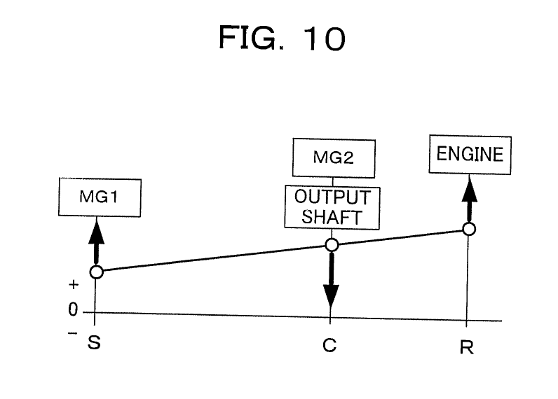

Since, according to the drive device of the vehicle 1A, the speed reduction mechanism 15 is configured as a chain transmission mechanism, accordingly no speed reduction gear train is required for reducing the rotational speed of the output shaft 8. Accordingly, there is no requirement for providing mounting space in the vehicle for housing any such speed reduction gear train. Moreover, as shown in FIG. 10, the output shaft 8 is linked to the carrier C that is positioned at the center upon the nomogram of the power splitting mechanism 6, the engine is linked to the ring gear R that is lined up on one side of the carrier C in the nomogram, and the first motor-generator 4 is linked to the sun gear S that is lined up on the other side of the carrier C in the nomogram. Due to this, it is not necessary to set the speed reduction ratio very high, since there are many opportunities to drive in a speed reduction state in which the rotational speed of the output shaft 8 becomes lower than the engine rotational speed. Accordingly, in order to obtain an appropriate speed reduction ratio, it will be adequate to make the ratio of the diameters of the driving sprocket 20 and the driven sprocket 21 small. In other words, the result of relaxation of the constraint upon reduction of the diameter of the driving sprocket 20, is that it is possible to suppress enlargement of the chain width of the belt chain 22. Due to this, it is possible to suppress deterioration of the vehicle mounting characteristics, the deterioration being caused by increase of the chain width.

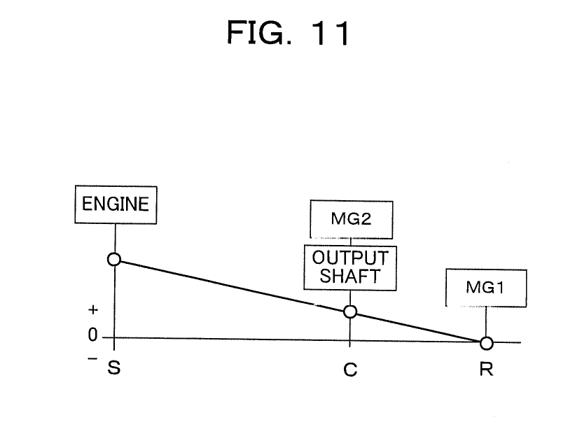

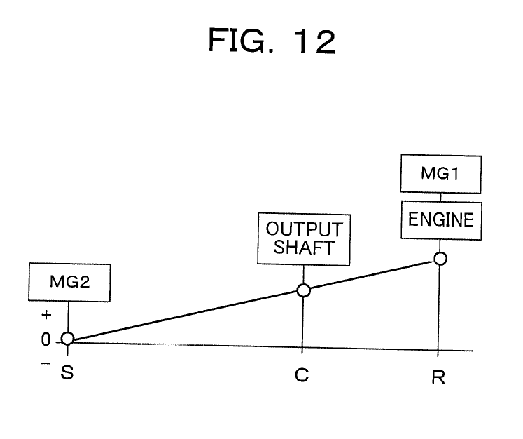

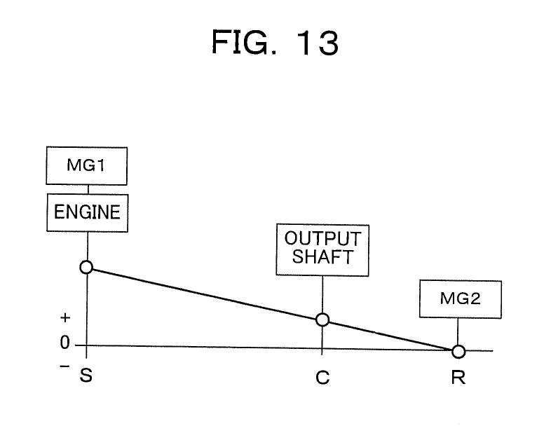

In the case of this vehicle 1A, the sun gear S to which the first motor-generator 4 is linked corresponds to the “first rotating element” of the present invention, the carrier C to which the output shaft 8 is linked corresponds to the “second rotating element” of the present invention, and the ring gear R to which the engine 3 is linked corresponds to the “third rotating element” of the present invention. For example, the three formats shown in FIGS. 11 through 13 could be variations of the format for linking up these rotating elements of the power splitting mechanism 6. In the first linking format shown in FIG. 11, in the power splitting mechanism 6, the engine 3 is linked to the sun gear S, while both the output shaft 8 and the second motor-generator 5 are linked to the carrier C and the first motor-generator 4 is linked to the ring gear R. Moreover, in the second linking format shown in FIG. 12, in the power splitting mechanism 6, the second motor-generator 5 is linked to the sun gear S, the output shaft 8 is linked to the carrier C, and both the engine 3 and the first motor-generator 4 are linked to the ring gear R. Yet further, in the third linking format shown in FIG. 13, in the power splitting mechanism 6, both the engine 3 and the first motor-generator 4 are linked to the sun gear S, the output shaft 8 is linked to the carrier C, and the second motor-generator 5 is linked to the ring gear R.

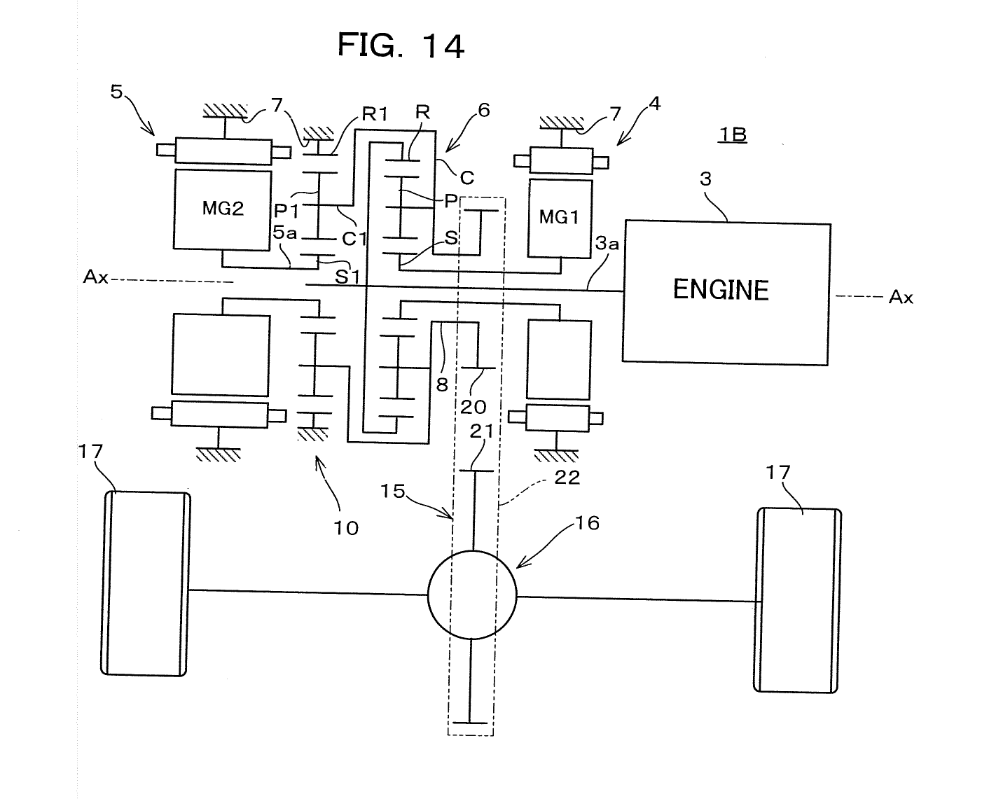

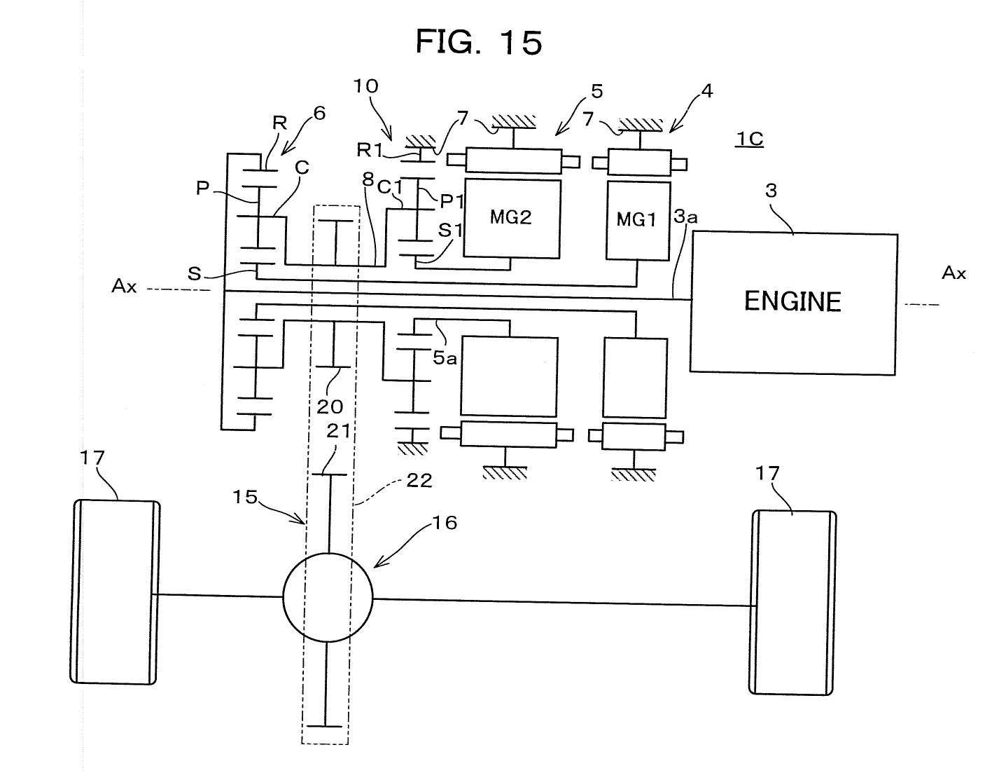

Furthermore, a vehicle 1B and a vehicle 10 are shown in FIGS. 14 and 15 in which the configuration is varied of the various structural elements of the vehicle 1A described above, such as the motor-generators 4 and 5 and the power splitting mechanism 6 and so on. Since nomograms that are the same as the nomogram for the vehicle 1A (refer to FIG. 10) apply to these vehicles 1B and 1C as well, accordingly it is similarly possible to suppress deterioration of the vehicle mounting characteristics. It should be understood that, in relation to the vehicles 1B and 10, structures that are the same as corresponding ones of the vehicle 1A are denoted by the same reference symbols, and explanation thereof is curtailed. In the vehicle 1B of FIG. 14, the first motor-generator 4 and the second motor-generator 5 are arranged separately, and the output shaft 8 and the power splitting mechanism 6 are disposed between them. Moreover, in the vehicle 1C of FIG. 15, the first motor-generator 4 and the second motor-generator 5 are arranged adjacent to one another, and the output shaft 8 is disposed between these motor-generators 4 and 5 and the power splitting mechanism 6. And, in the vehicle 1C, the belt chain 23 of the speed reduction mechanism 15 and the differential mechanism 16 are offset from the center of the vehicle toward the left side in FIG. 15.

### Embodiment #2

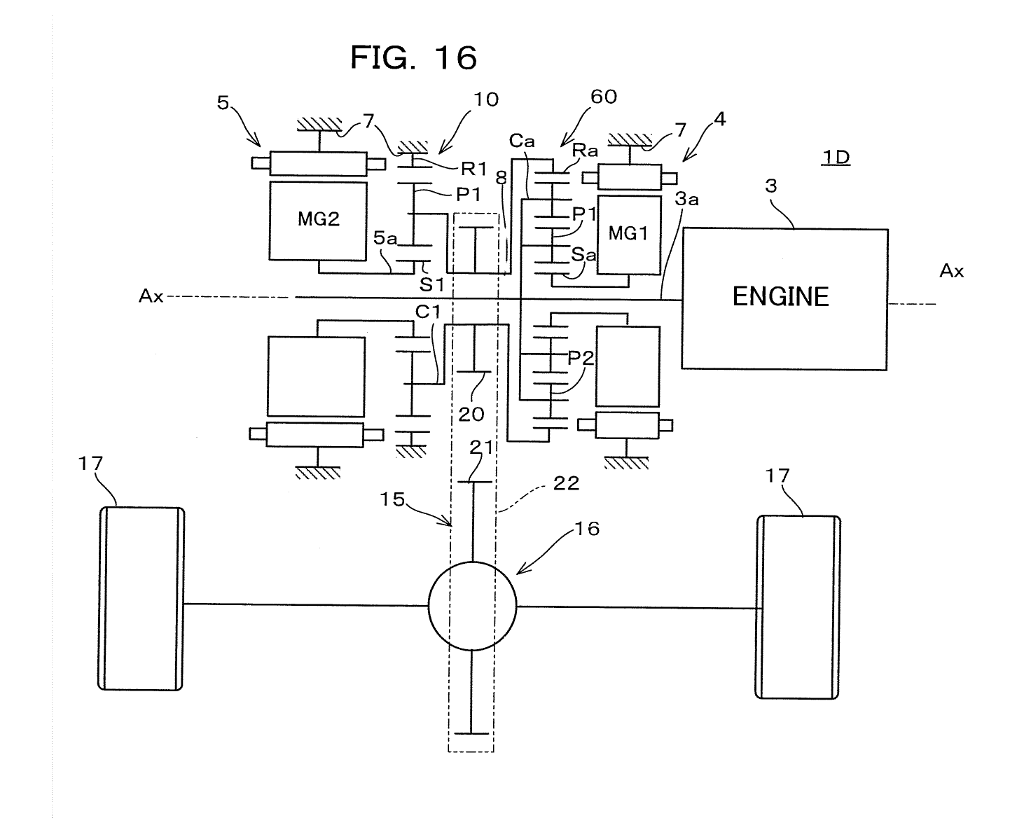

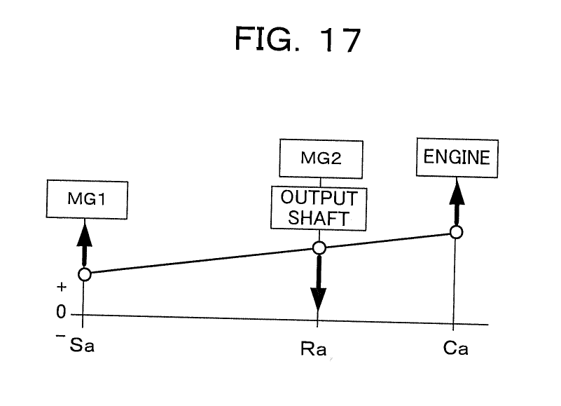

Next, a second embodiment of the present invention will be explained with reference to FIGS. 16 and 17. The vehicle 1D to which this drive device of the second embodiment is applied has a power splitting mechanism 60 that is built as a double pinion type planetary gear mechanism. It should be understood that elements of the structure of the vehicle 1D that are the same as elements of the vehicles 1A through 1C described above are denoted by the same reference symbols, and explanation thereof is omitted.

The power splitting mechanism 60 comprises a sun gear Sa that is an externally toothed gear wheel, a ring gear Ra that is disposed coaxially with the sun gear Sa and is an internally toothed gear wheel, and a carrier Ca that supports first pinions Pal that are engaged with the sun gear Sa and second pinions Pa2 that are engaged with the ring gear, so that these pinions Pa1 and Pa2 are rotatable and revolvable in a state that the pinions Pa1 and Pa2 are mutually engaged with one another. The engine torque outputted by the engine 3 is transmitted to the carrier Ca of the power splitting mechanism 60. The first motor-generator 4 is linked to the sun gear Sa of the power splitting mechanism 60. And the torque outputted via the ring gear Ra of the power splitting mechanism 60 is transmitted to the output shaft 8, which serves as an output member.

As shown in FIG. 17, in this vehicle 1D, the output shaft 8 is linked to the ring gear Ra which is positioned in the center upon the nomogram, the engine 3 is linked to the carrier Ca which is arranged on one side of the ring gear Ra in the nomogram, and the first motor-generator 4 is linked to the sun gear Sa which is arranged on the other side of the ring gear Ra in the nomogram. Due to this, with this vehicle 1D as well, in the same way as with the vehicle 1A, it is not necessary to set the speed reduction ratio very high, since there are many opportunities to drive in a speed reduction state in which the rotational speed of the output shaft 8 becomes lower than the engine rotational speed. Accordingly, the result of relaxation of the constraint upon reduction of the diameter of the driving sprocket 20 of the speed reduction mechanism 15, is that it is possible to suppress enlargement of the chain width of the belt chain 22. Due to this, in a similar manner to the case of the vehicle 1A, it is possible to avoid deterioration of the vehicle mounting characteristics, the deterioration being caused by increase of the chain width.

In the case of this vehicle 1D, the sun gear Sa to which the first motor-generator 4 is linked corresponds to the “first rotating element” of the present invention, the ring gear Ra to which the output shaft 8 is linked corresponds to the “second rotating element” of the present invention, and the carrier Ca to which the engine 3 is linked corresponds to the “third rotating element” of the present invention. As variations of the way in which the rotating elements of the power supply mechanism 60 are linked, similar ones to the formats shown in FIGS. 11 through 13 are also possible.

The present invention is not to be considered as being limited to the embodiments disclosed above; it would be possible to implement the present invention in various different embodiments. For example, while in the implementations described above the chain links 23 of the belt chain 22 of the speed reduction mechanism 15, the driving tooth portions 27 of the driving sprocket 20, and the driven tooth portions 28 of the driven sprocket 21 were all formed as being asymmetric, it would be possible to obtain the beneficial effect of the present invention such that the difference in the up and down motion is reduced, provided that at least one or more of these is formed as being asymmetric. Accordingly, the present invention could be implemented in various kinds of embodiments, in each of which at least one set of components: the chain links 23; the driving tooth portions 27; and the driven tooth portions 28 are formed as being asymmetric.

This application claims the benefit of foreign priority to Japanese Patent Application No. JP2016-059932, filed Mar. 24, 2016, which is incorporated by reference in its entirety.

1. A drive device for a hybrid vehicle, comprising:
an engine;
a motor-generator;
an output member that outputs torque;
a power splitting mechanism having a first rotating element, a second rotating element, and a third rotating element which are arranged on a nomogram in order of the first rotating element, the second rotating element, and the third rotating element, and also arranged so that the engine is linked to a first one which is any one of either the first rotating element or the third rotating element, the motor generator is linked to a second one which is any one of either the first rotating element or the third element but different from the first one, and the output member is linked to the second rotating element;
a differential mechanism that distributes torque to left and right drive wheels; and
a speed reduction mechanism that transmits the torque of the output member to the differential mechanism, and reduces speed of rotation of the output member;
wherein the speed reduction mechanism is configured as a chain transmission mechanism comprising a driving sprocket that rotates integrally with the output member, a driven sprocket provided to the differential mechanism and having a larger diameter than the driving sprocket, and a belt chain that is fitted around the driving sprocket and the driven sprocket.

2. The drive device according to claim 1, wherein:
the belt chain comprises a plurality of chain links that are engaged to the driving sprocket and to the driven sprocket;
each of the plurality of chain links has:
a first tooth surface that is positioned in the chain link at a side of a forward rotational direction which is a direction in which the driving sprocket and the belt chain engaged to the driving sprocket rotate during forward movement of the hybrid vehicle, and
a second tooth surface that is positioned in the chain link at a side of a reverse rotational direction which is opposite to the forward rotational direction, and that opposes the first tooth surface; and
each first tooth surface has a raised portion that bulges out toward the second tooth surface.

3. The drive device according to claim 2, wherein:
the driving sprocket has a plurality of driving tooth portions that are formed at a predetermined pitch, and each of the plurality of driving tooth portions has a first driving side tooth surface that is positioned at the side of the forward rotational direction in the driving tooth portion and a second driving side tooth surface that is positioned at the side of the reverse rotational direction in the driving tooth portion; and,
when a straight line that connects a vertex of the driving tooth portion to a rotational center of the driving sprocket is taken as a reference, the first driving side tooth surface is bulged out in a direction away from the straight line, as compared to the second driving side tooth surface.

4. The drive device according to claim 2, wherein
the driven sprocket has a plurality of driven tooth portions that are formed at a predetermined pitch, and each of the plurality of driven tooth portions has a first driven side tooth surface that is positioned at the side of the forward rotational direction in the driven tooth portion and a second driven side tooth surface that is positioned at the side of the reverse rotational direction in the driven tooth portion; and,
when a straight line that connects a vertex of the driven tooth portion to a rotational center of the driven sprocket is taken as a reference, the second driven side tooth surfaces is bulged out in a direction away from the straight line, as compared to the first driven side tooth surface.

5. The drive device according to claim 3, wherein
the driven sprocket has a plurality of driven tooth portions that are formed at a predetermined pitch, and each of the plurality of driven tooth portions has a first driven side tooth surface that is positioned at the side of the forward rotational direction in the driven tooth portion and a second driven side tooth surface that is positioned at the side of the reverse rotational direction in the driven tooth portion; and,
when a straight line that connects a vertex of the driven tooth portion to a rotational center of the driven sprocket is taken as a reference, the second driven side tooth surfaces is bulged out in a direction away from the straight line, as compared to the first driven side tooth surface.
